(19) United States
(12) Patent Application Publication
(10) Pub. No.: US 2008/0181588 A1
(43) Pub. Date: Jul. 31, 2008

(54) THREE-DIMENSIONAL PANEL FOR USE IN ELECTRIC FIREPLACES AND FIREPLACE INCORPORATING THE SAME

(75) Inventor: Gregory J. Gorby, Hanoverton, OH (US)

Correspondence Address: SAND & SEBOLT, AEGIS TOWER, SUITE 1100, 4940 MUNSON STREET, NW, CANTON, OH, 44718-3615, US

(73) Assignee: REFRACTORY SPECIALTIES, INCORPORATED, Sebring, OH (US)

(21) Appl. No.: 11/964,910

(22) Filed: Dec. 27, 2007

Related U.S. Application Data
(63) Continuation-in-part of application No. 11/699,727, filed on Jan. 30, 2007.

(51) Int. Cl. F24B 1/18; F24C 7/00; G09F 19/00

(52) U.S. Cl. 392/348; 40/428

(57) ABSTRACT

A three-dimensional panel used in an electric fireplace to simulate a firebox of a wood burning fireplace and an electric fireplace incorporating the same. The electric fireplace includes housing having a light source positioned so as to transmit light through the panel. The panel is vacuum-molded to have a pattern formed therein and thereon. The pattern represents elements found in a wood burning fireplace such as firebricks, stoneworks, logs, a logset, a grate and embers or any other elements typically found in a wood-burning fireplace's firebox. The pattern is formed by a combination of molding these elements into the materials from which the panel is made and applying coloring agents to the panel either during the molding process or after the panel has been formed. The panel may be positioned between an artificial logset and the light source if the logset is not molded into the panel.

### CROSS-REFERENCE TO RELATED APPLICATIONS

This application is a Continuation-In-Part of U.S. patent application Ser. No. 11/699,727, filed Jan. 30, 2007, the entire specification of which is incorporated herein by reference.

### BACKGROUND OF THE INVENTION

1. Technical Field

This invention generally relates to fireplaces. More particularly, the invention relates to electric fireplaces which simulate the appearance of a wood-burning or gas-burning fireplace. Specifically, the invention relates to a three-dimensional panel having a pattern of elements of a firebox molded and colored thereon, where the panel is positionable in front of a light source in an electric fireplace to simulate a wood-burning fireplace.

2. Background Information

Fireplaces may add to the warmth and ambiance of any room. However, in many locations, installing a wood-burning or gas-burning fireplace is not practical or even possible because of space constraints or venting issues. In warmer climates, on the other hand, homeowners may want the ambiance offered by a fireplace but do not want any heat to be emitted therefrom. It is in these instances that electric fireplaces are the ideal solution.

An electric fireplace will only tend to add to the appearance of a room if it creates an effective illusion that it is a wood-burning or gas-burning fireplace. This has caused manufacturers to include various components in electric fireplaces that are essentially decorative and not functional. So, for example, electric fireplaces include a grate, artificial firelogs and embers, and none of these components contribute to the production of heat from the fireplace. Furthermore, the fireplaces have included mechanisms for creating the illusion of burning firelogs. These mechanisms have included providing a rotating cylinder that has flame-shaped apertures formed in its exterior surface. A light is shone through the rotating cylinder and onto a diffuser screen positioned behind the firelogs. Other fireplaces, such as those disclosed in U.S. Pat. Nos. 6,393,207 and 6,757,487 both issued to Martin et al, include a screen on which colored flame-shaped images are silk-screened. A light is shone through an apertured rotating cylinder positioned rearwardly of the screen and the moving light causes the silk-screened images to appear to flicker, thereby creating the illusion of burning logs

Another of the components that manufacturers have needed to include, but which does not serve any functional purpose, is a firebox in which the grate, artificial firelogs and embers are presented. So, for example in the patents to Martin et al referenced previously, a simulated firebox insert having a top, a bottom, a back and sides, is positioned within a cavity in a housing. The sides of the insert are painted to appear like firebricks or, alternatively, ceramic fiber refractory panels which are appropriately shaped and colored are attached to the interior sides of the insert. These additional components add to the cost of manufacturing the electric fireplace.

There is therefore a need in the art for an improved electric fireplace that has the illusion of a firebox for a wood-burning or gas-burning fireplace, but that does not require the actual construction of a firebox during manufacture of the unit.

### SUMMARY OF THE INVENTION

The device of the present invention comprises a three-dimensional panel used in an electric fireplace to simulate a firebox of a wood burning fireplace and an electric fireplace incorporating the same. The electric fireplace includes housing having a light source positioned so as to transmit light through the panel. The panel is vacuum-molded to have a pattern formed therein and thereon. The pattern represents elements found in a wood burning fireplace such as firebricks, stoneworks, logs, a logset, a grate and embers or any other elements typically found in a wood-burning fireplace's firebox. The pattern is formed by a combination of molding these elements into the materials from which the panel is made and applying coloring agents to the panel either during the molding process or after the panel has been formed. The panel may be positioned between an artificial logset and the light source if the logset is not molded into the panel.

### BRIEF DESCRIPTION OF THE DRAWINGS

The preferred embodiments of the invention, illustrative of the best mode in which applicant has contemplated applying the principles, are set forth in the following description and are shown in the drawings and are particularly and distinctly pointed out and set forth in the appended claims.

FIG. 1 is a front elevational view of an electric fireplace in accordance with the present invention;

FIG. 2 is a cross-sectional side view of the electric fireplace taken through line 2-2 of FIG. 1;

FIG. 3 is a front view of a first embodiment of a panel for use in the electric fireplace of FIG. 1;

FIG. 4 is a front view of a second embodiment of a panel for use in the electric fireplace;

FIG. 5 is a front view of a third embodiment of a panel for use in the electric fireplace;

FIG. 6 is a side view of a fourth embodiment of a panel for use in the electric fireplace;

FIG. 7 is a front elevational view of an alternative embodiment of a fireplace in accordance with the present invention;

FIG. 8 is a cross-sectional side view of the electric fireplace of FIG. 7.

FIG. 9 is a front elevational view of a further alternative embodiment of a fireplace in accordance with the present invention;

FIG. 10 is a cross-sectional side view of the electric fireplace taken through line 10-10 of FIG. 9;

FIG. 11 is a front elevational view of a first embodiment of the three-dimensional panel in accordance with the present invention;

FIG. 12 is a rear perspective view of the panel of FIG. 11;

FIG. 13 is an enlarged rear perspective view of the highlighted region of FIG. 12;

FIG. 14 is a side view of the panel taken through line 14-14 of FIG. 13;

FIG. 15 is front elevational view of a second embodiment of the three-dimensional panel in accordance with the present invention; and

FIG. 16 is a rear perspective view of the panel of FIG. 15.

### DETAILED DESCRIPTION OF THE INVENTION

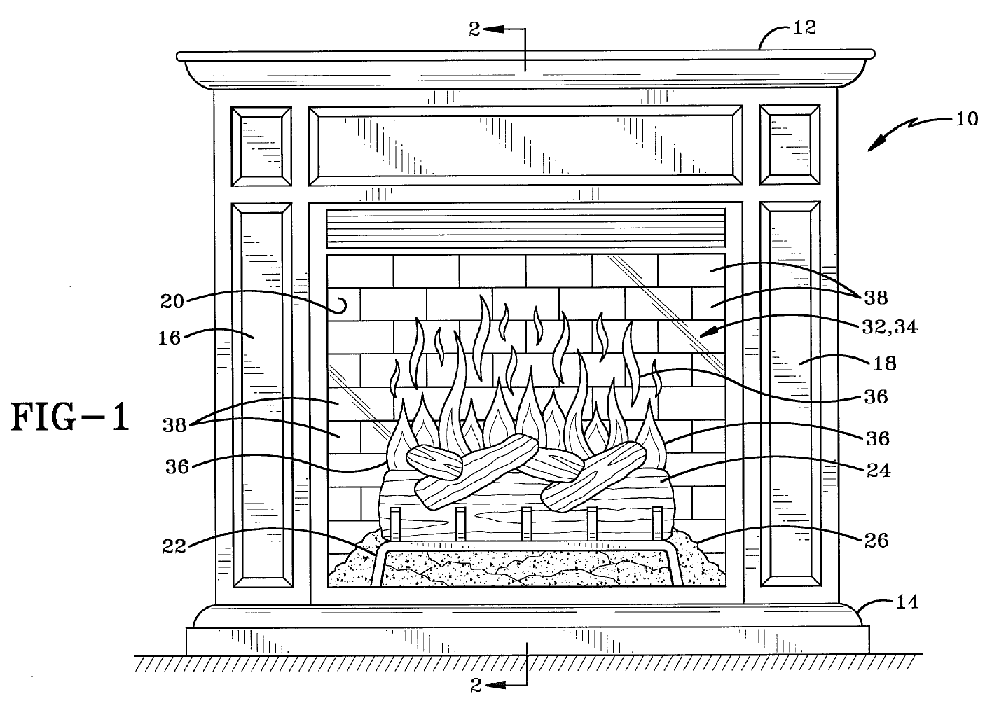

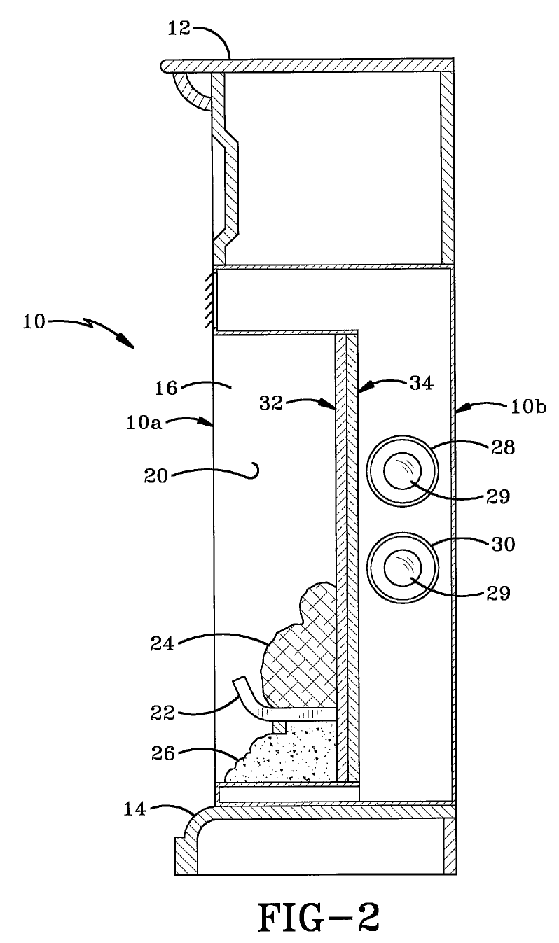

Referring to FIGS. 1-6, there is shown an electric fireplace 10 in accordance with the present invention. Fireplace 10 comprises a housing that includes a mantel 12, a base 14 and side panels 16, 18 that surround and define an interior cavity 20. Fireplace 10 has the appearance of being a natural wood-burning fireplace when viewed from a front end 10a thereof and includes a grate 22, artificial firelogs 24 and an ember bed 26 which are positioned within cavity 20. A light source (not shown) may be provided in base 14 to illuminate ember bed 26 from beneath, as is known in the art.

One or more rotatable cylinders 28, 30 may be positioned rearwardly of firelogs 24. Cylinders 28, 30 each have an outer surface in which a plurality of flame-shaped apertures (not shown) are formed. Light from a light source 29 shines through the outer surface of cylinders 28, 30 and through these flame-shaped apertures. As the cylinders 28, 30 rotate, the light shining through the apertures is directed forwardly toward front end 10a of fireplace 10 and onto a diffuser screen 32. An image of a plurality of flames 36 is thereby formed on diffuser screen 32 by the light.

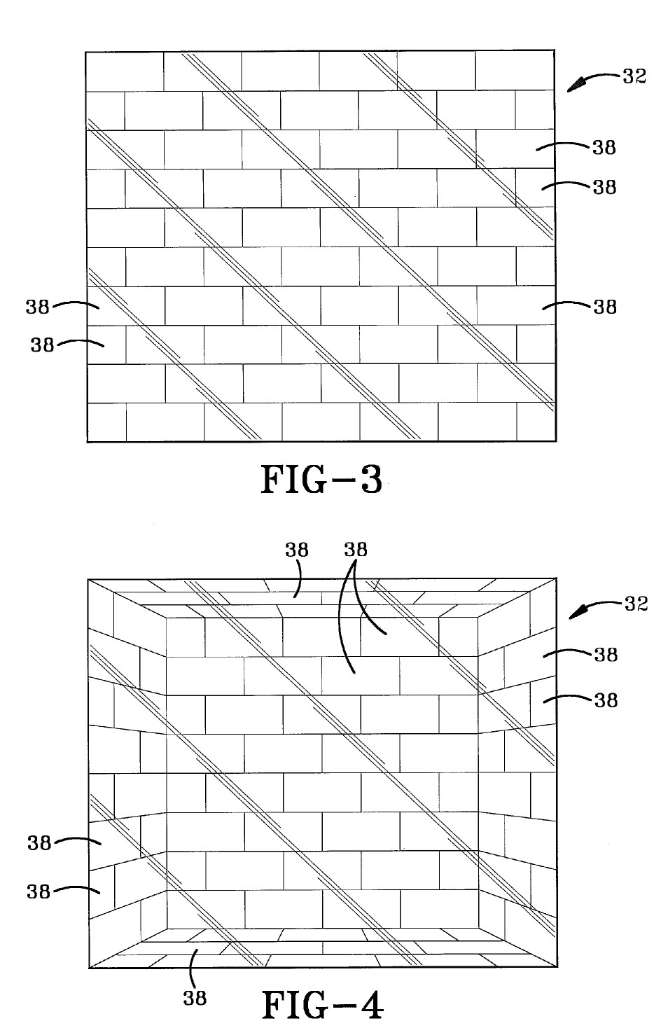

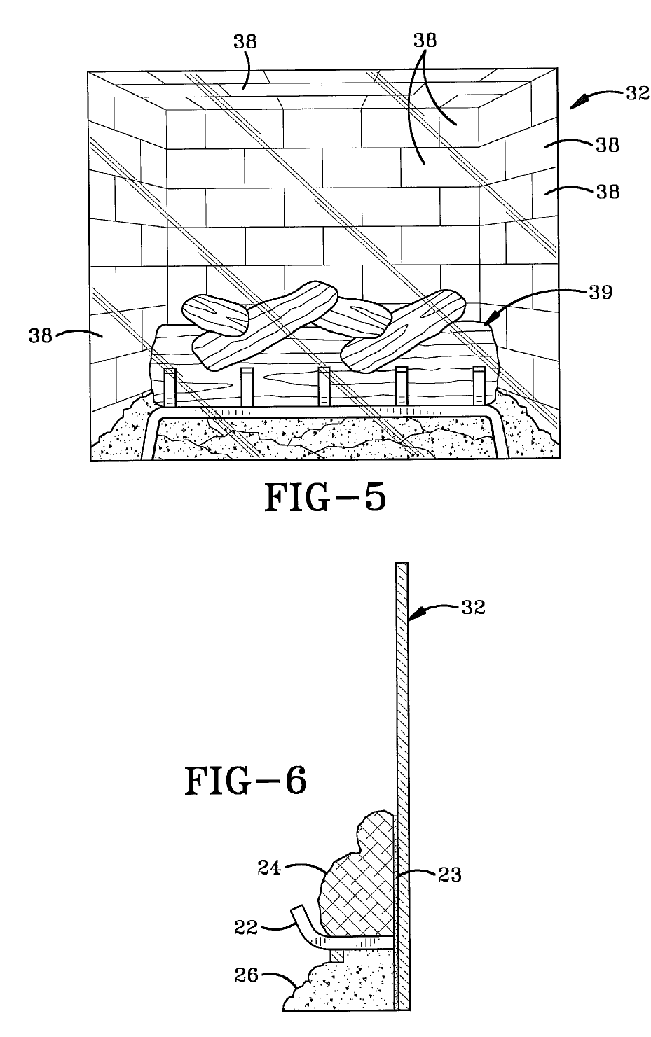

In accordance with a specific feature of the present invention, fireplace 10 is provided with a panel 34 situated between diffuser screen 32 and cylinders 28, 30. Panel 34 preferably is a planar sheet that is at least partially one of opaque, translucent or transparent to allow some light to be transmitted therethrough. Panel 34 is provided with a pattern thereon to represent the interior of a firebox of a wood-burning fireplace. In the preferred embodiment of the invention, pattern 38 is one of a plurality of firebricks. This is illustrated in a first embodiment in FIG. 3 where the panel shows a flat wall of firebricks. In a second embodiment shown in FIG. 4, the panel shows a recessed wall of firebricks. It will be understood, however, that any other suitable pattern may be utilized on panel 34, such as one to simulate the stonework of a firebox in a stone fireplace. Furthermore, the pattern 38 may also include a three-dimensionally recessed or protruding logset 39 which includes a plurality of logs seated on a grate above an ember bed. This third embodiment is shown in FIG. 5.

It will also be understood that the pattern 38 preferably is produced at least partially in color. The pattern 38 is formed on panel 34 any suitable method including silk screening, painting, etching or any combination of these.

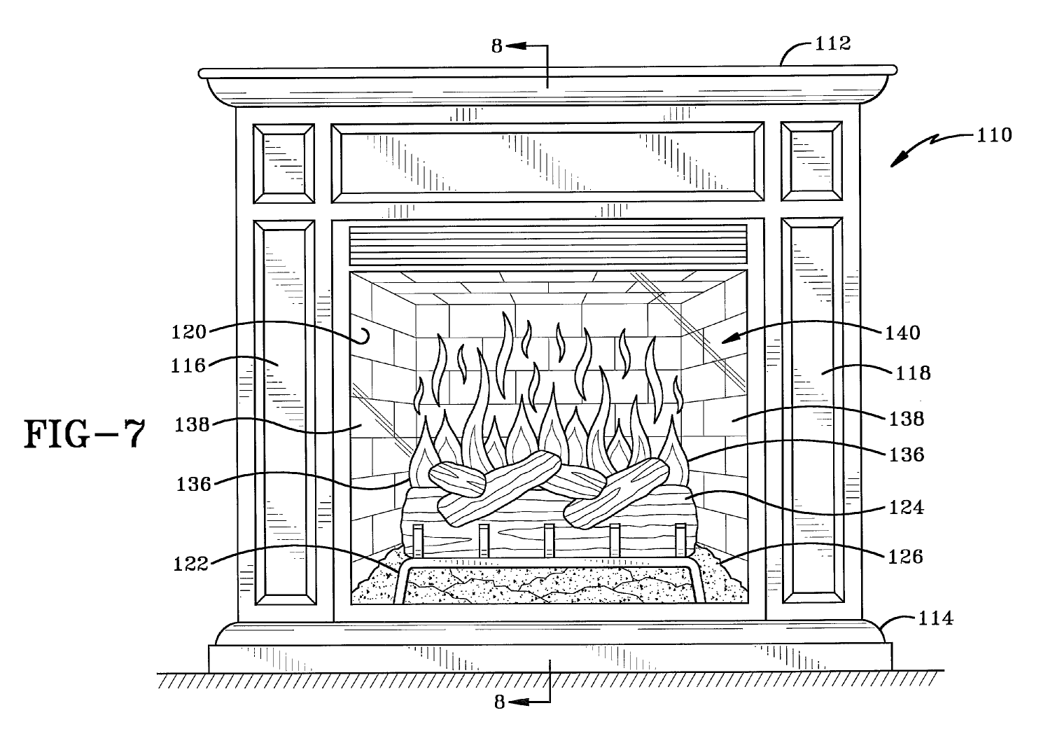

While panel 34 has been disclosed above to preferably be a planar sheet, it will be understood that panel 34 may also be integrally formed with or otherwise attached to the logset without departing from the spirit of the present invention. This fourth embodiment is shown in FIG. 6 where the panel 32 is attached by an adhesive 23 to one or more of the grate 22, logs 24 and ember bed 26.

Fireplace 10 is used in the following manner. A switch (not shown) is used to activate both the light source 29 and cylinders 28, 30. As cylinders 28, 30 are rotated, the light from light source 29 passes through the flame-shaped apertures in the rotating cylinders 28, 30, through panel 34 and through diffuser screen 32. The pattern of firebricks 38 on panel 34 is illuminated by the light forming the flame-shaped images 36 on diffuser screen 32. This creates the illusion, when viewed from the front end 10a of fireplace 10, that the firelogs 24 are burning and that the flames are illuminating a portion of the firebox in which the logs are situated. The illusion of a firebox is thus created by the provision of the planar panel 34. There is therefore no need for the construction of a specially shaped firebox to be received within a cavity of the fireplace housing. The panel 34 is simply positioned across a rear portion of the generally rectangular cavity 20 formed by the mantel, base and sides. There is also no need for painting a brickwork pattern onto the interior side walls of a specially shaped firebox or for the attachment of ceramic fiber panels onto the interior side walls thereof. Panel 34 therefore reduces the time required and the cost for manufacturing an electric fireplace.

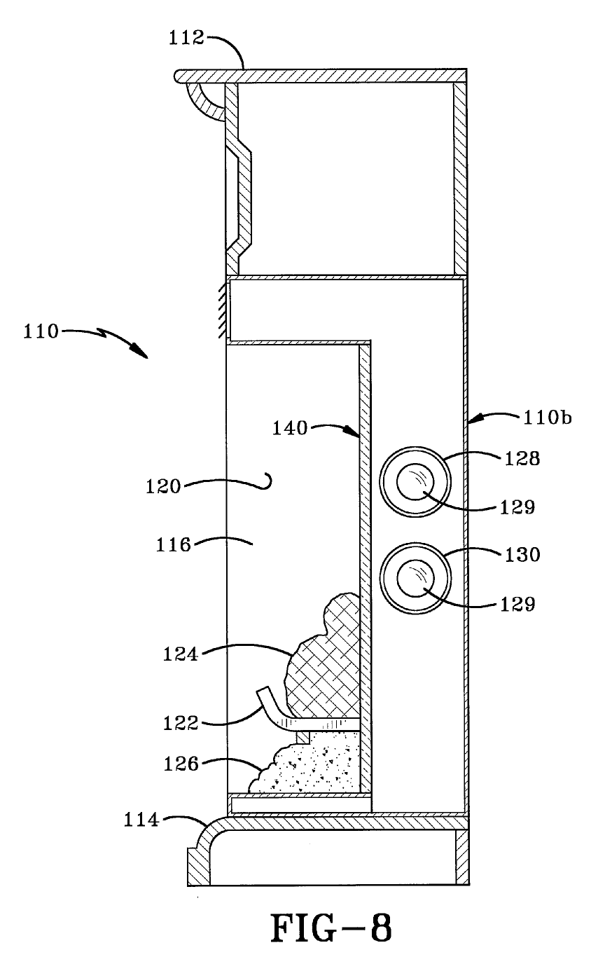

Referring to FIGS. 7 and 8, there is shown an alternative embodiment of a fireplace in accordance with the present invention and generally indicated at 110. Fireplace 110 includes a housing having a mantel 112, a base 114 and side panels 116, 18 that surround and define an interior cavity 120. Fireplace 110 includes a grate 122, artificial firelogs 124, and ember bed 126 positioned within the cavity 120. As with the previous embodiment, a light source 129 is provided to shine through flame-shaped apertures in cylinders 128, 130. In this instance, fireplace 10 includes a single diffuser panel 140 positioned intermediate firelogs 124 and cylinders 128, 130. Panel 140 is a planar sheet that is at least partially one of opaque, translucent and transparent and is provided with a pattern 138 of firebricks thereon. Pattern 138 is formed by silk-screening, painting or etching firebricks onto the diffuser panel 140. When diffuser panel 140 is illuminated with the flame pattern produced by light shining through the flame-shaped apertures in cylinders 128, 130, panel 140 creates the illusion that fireplace 110 includes a firebox in which the firelogs 124 are burning. The pattern 138 on diffuser panel 140 may be of any suitable type such as that illustrated in FIG. 7. It will be understood, however, that any other suitable pattern may be utilized on panel 140, such as one to simulate a flat brick wall or a firebox of a stone fireplace, for example.

It will be understood that the illusion of the flames may be created in a manner other than by shining light through flame-shaped apertures in one or more rotating cylinders, without departing from the spirit of the present invention. So, for example, light from the light source may shine directly on the panel or the fireplace may include a screen in which the flames are preformed such as by silk-screening or painting. Furthermore, the pattern 38, 138 of the firebricks disclosed and claimed herein may be superimposed upon any such screen.

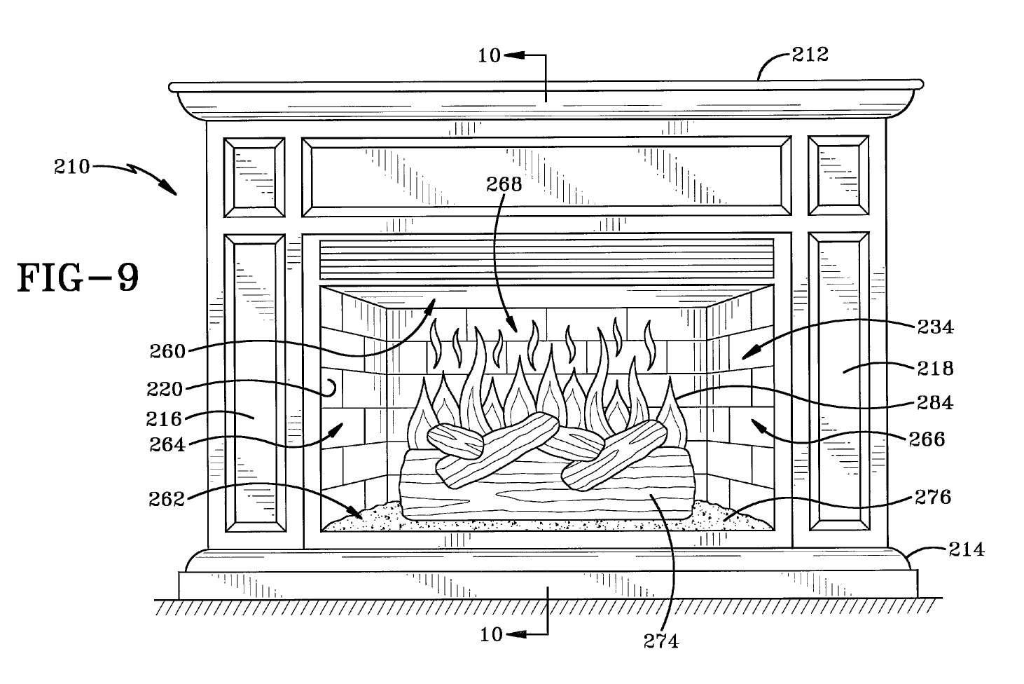

Referring to FIGS. 9-14 there is shown an further embodiment of an electric fireplace in accordance with the present invention and being generally indicated at 210. Fireplace 210 comprises a housing that includes a mantel 212, a base 214 and side panels 216, 218 that surround and define an interior cavity 220. Fireplace 210 has the appearance of being a natural wood-burning fireplace when viewed from a front end 210a thereof. A light source (not shown) may be provided in base 214 to illuminate panel 234 from beneath.

One or more rotatable cylinders 228, 230 may be provided in fireplace 210. If provided, cylinders 228, 230 may each have an outer surface in which a plurality of apertures (not shown) are formed. Light from a light source 229 shines through the outer surface of cylinders 228, 230 and through these apertures. As the cylinders 228, 230 rotate, the light shining through the apertures is directed forwardly toward front end 210a of fireplace 210. The apertures may be flame shaped or shaped in any other desired pattern. Alternatively, as mentioned previously, cylinders 228, 230 do not need to be provided in order to generate the flickering flame images. Instead, light from light source 229 may shine directly onto panel and the relief or profile created in the panel itself may create the flickering flame illusion in the panel.

In accordance with a specific feature of the present invention, fireplace 210 is provided with a three-dimensional molded panel 234 that is positioned in front of cylinders 228, 230. Panel 234 preferably is a unitary member that is molded from PETG (glycol-modified polyethylene terephthalate). It will be understood that other types of vacuum formable or castable plastics may be used with the castable plastics being brushed, poured or injected. The PETG preferably is between 0.009″ and 0.063″ thick, although greater thicknesses of the plastic, such as around 0.125″ thick could be used when spanning larger distances to prevent bowing of panel 234. Thinner plastic may also be utilized. Panel 234 is manufactured in such a way as to be transparent, opaque or translucent so that light may travel therethrough.

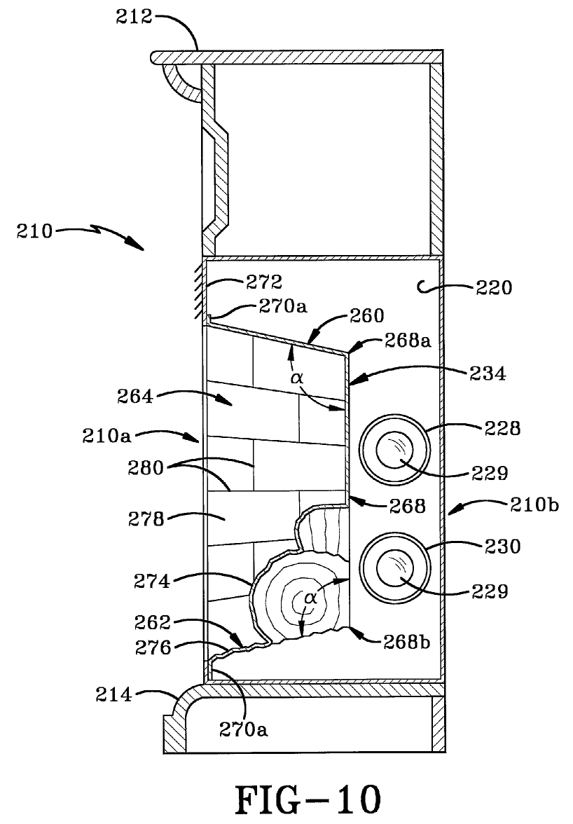

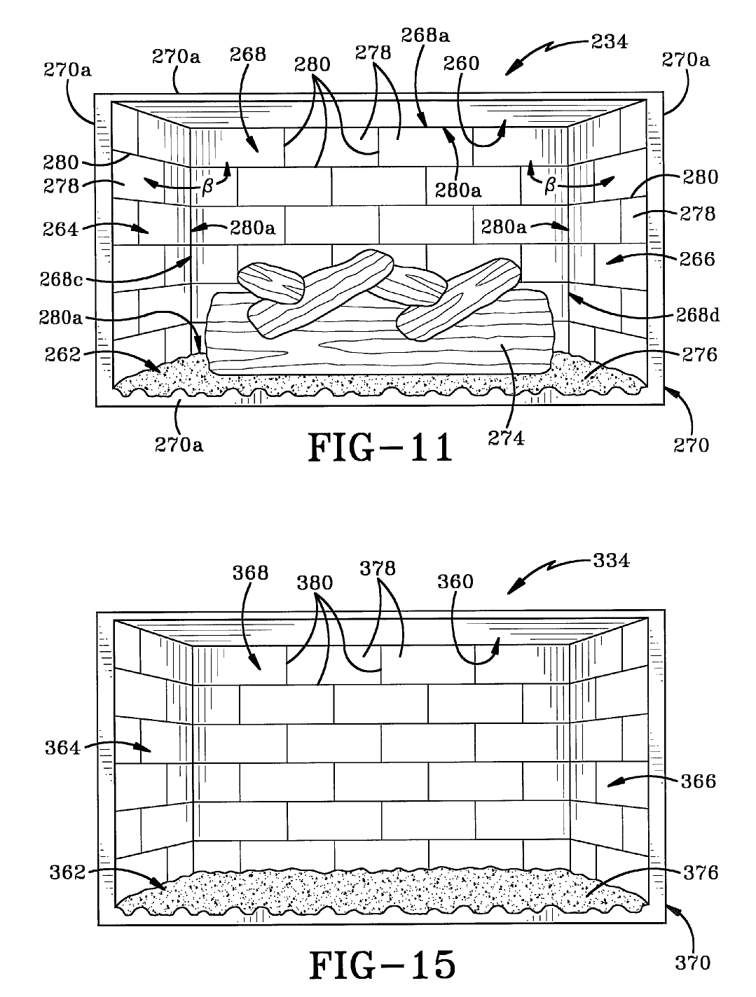

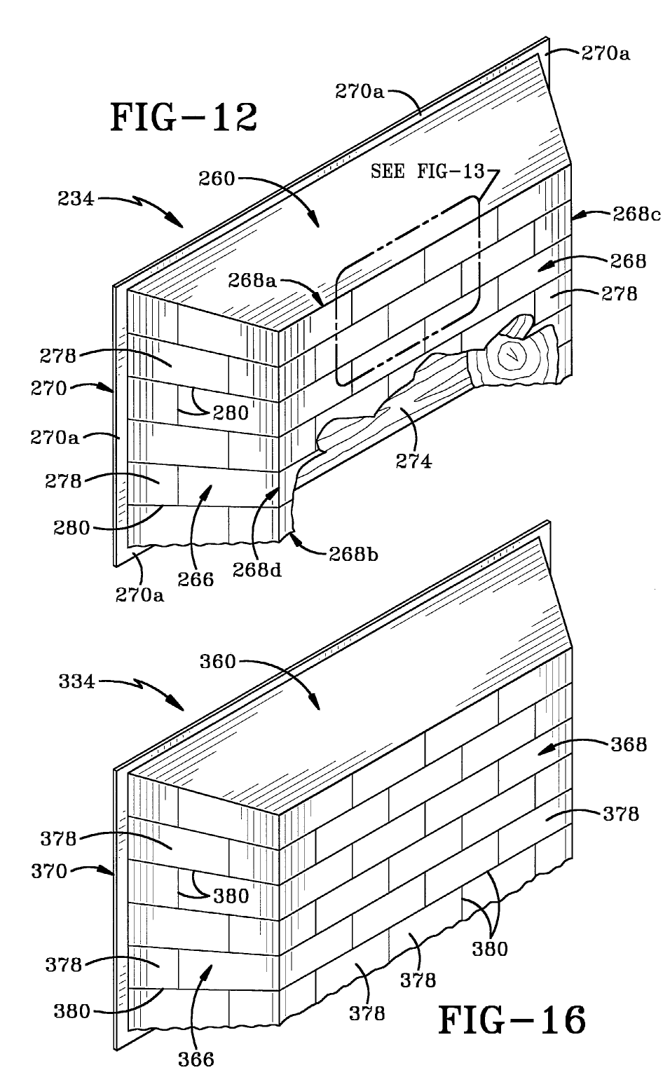

Panel 234 includes a top wall 260, a bottom wall 262, side walls 264, 266 and a back wall 268, all of which are preferably integrally connected to each other. The top, bottom, side and back walls could, however, be separately formed and joined together in a suitable manner. Top, bottom, side and back walls are positioned at angles relative to each other with the angle being established by the desired finished appearance of panel 234 and the amount of perspective that it is desired that the panel should have. Bottom wall 262 constitutes a base from which top, sides and bottom walls 260, 264, 266 and 262 extend outwardly and forwardly. Top wall 262 extends outwardly and slightly upwardly away from a top end 268a (FIG. 10) of back wall 268. Bottom wall 262 extends outwardly and slightly downwardly from a bottom end 268b of back wall 268. Preferably, top wall 260 and bottom wall 262 are at an angle α of between 0 degrees and 90 degrees relative to the planar vertical surface of back wall 268 and preferably between 30 degrees and 90 degrees, although any other suitable angle may be selected. To date, panels 234 have been produced with angle α being set at 44 degrees, 51 degrees, 61 degrees and 77 degrees. Side wall 264 extends outwardly from a first side 268c (FIG. 11) of back wall 268. Side wall 266 extends outwardly from a second side 268d of back wall 268. Preferably, side walls 264, 268 are at an angle β relative to the planar surface of back wall 268 and therefore flare outwardly away from back wall 268. It has been found that angle β preferably is similar to angle α, and finished panels have been produced with angle β being set at between 40 degrees and 60 degrees. Each side wall 264, 268 is also integrally connected between a portion of top wall 260 and a portion of bottom wall 262. A flange 270 frames the front edges of top, bottom and side walls 260, 262, 264 and 266 and creates a lip 270a (FIG. 12) that radiates outwardly away from the outer surfaces of these walls. When panel 234 is placed in fireplace 210, the lip 270a of flange 270 butts up against an interior surface 272 of the frame formed by the mantel 212, base 214 and sides 216, 218 of fireplace 210. Flange 270 therefore is substantially hidden when fireplace 210 is viewed from the front as in FIG. 9. An adhesive or other suitable securement may be applied between flange 270 and the frame of fireplace 210.

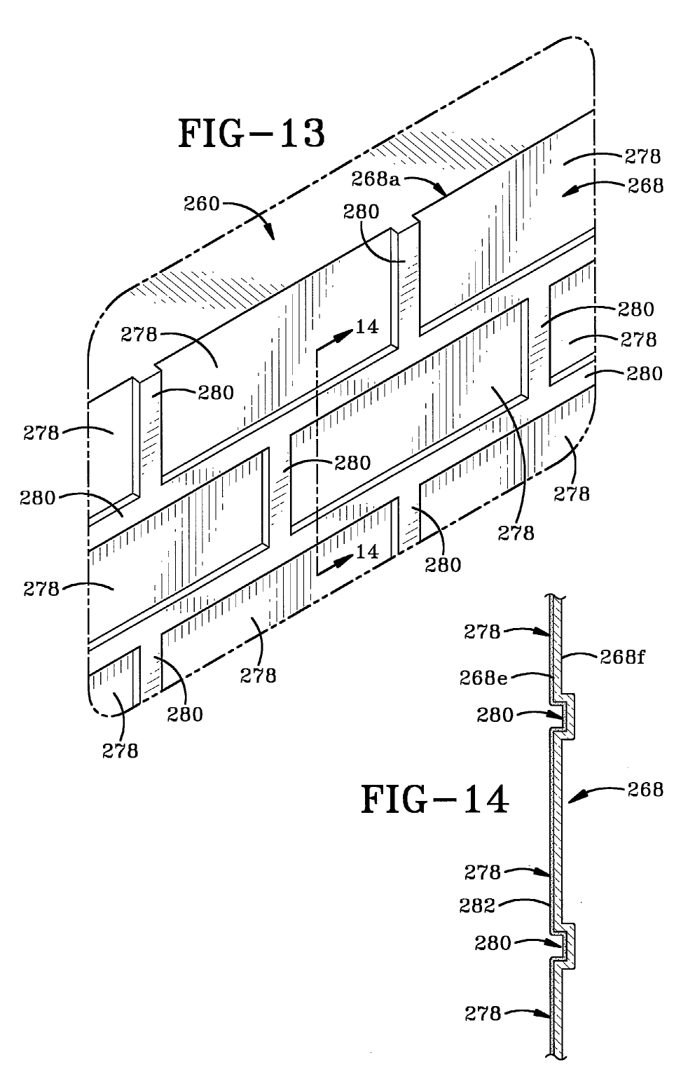

As shown in FIG. 12, a lowermost portion of back wall 268 and portion of bottom wall 262 may be molded into the shape of a logset 274 and embers 276. Logset 274 and embers 276 project forwardly and outwardly in front of the upper portion of back wall 268 and project upwardly from bottom wall 262. Furthermore, as shown in FIGS. 13 and 14, back wall 268 and side walls 264, 266 of panel 210 are molded into the shape of bricks 278 that are separated by channels of grout 280. The molded panel 210 may also be formed to include smaller protrusions and recesses (not shown) in the individual bricks 278 so that the walls of panel 210 have a more realistic and textured appearance. Preferably, the transitions between the back wall 268 and the top, bottom and side walls 260, 262, 264 and 266 are somewhat hidden by molding of grout lines 280 in those transition locations. This is indicated in FIG. 11 by lines 280a.

Paints, dyes or any other suitable coloring agents 282 may be applied over either of the front or rear surfaces of any or all of the walls of panel 234. This is illustrated in FIG. 14 where coloring agents 282 are applied over front surface 268e of back wall 268. Back surface 268f thereof is free of coloring agents. It will be understood that coloring agents could, however, also be applied over back surface 268f. Furthermore, the coloring agents may be applied in various regions of panel 234 to different degrees. In some regions of panel 234 the coloring agents may be applied in such a manner that light from light sources 229 passes easily through the coloring agent and is therefore visible from the front of fireplace 210. In other regions of panel 234, the coloring agents may be applied to a degree sufficient to substantially prevent light from being transmitted through those particular regions. So, for example, a quantity of the coloring agents may be applied to darken a large portion of the logs in the logset 274 thereby causing the logs to appear as substantially solid bodies. This occurs because the thickness and coloration of these regions substantially restrict light from light sources 229 from traveling therethrough. Alternatively, at least a portion of the coloring agents may be added into the material to be molded so that the molded panel 234 is at least partially colored during the molding process. Additional coloring agents may also be applied over this molded and colored panel. It will be understood that any of the top, bottom, side and back walls 260, 262, 264, 266 and 268 may be molded and colored to represent features typically found in a wood fireplace, including but not limited to bricks, stones, logs, embers, a grate and flames. Furthermore, at least one of the walls, such as top wall 260 may be molded so as to be free of texture, i.e., not including any bricks or stones or other fireplace features. This wall or other walls may also be devoid of any coloring agents if desired.

In use, panel 234 is placed in the frame formed by mantel 212, base 214 and sides 216, 218 so that flange 270 butts up against the interior walls of the fireplace frame and is not visible when fireplace 210 is observed from the front. Panel 234 is positioned within this frame so that the light sources 229 in cylinders 228, 230 will shine through back wall 268 and possibly through a portion of bottom wall 262 and side walls 264, 266 and give the appearance of flames 284 (FIG. 9) flickering in fireplace 210. An additional light source (not shown) may also be positioned beneath bottom wall 262 so that the embers 276 molded into the same will appear to flicker and glow. Fireplace 210 may also be provided with a noise generator (not shown) that emits sounds which simulate crackling wood, thereby enhancing the illusion that this electric device is in fact a wood burning fireplace.

Referring to FIGS. 15 and 16, there is shown a second embodiment of a three dimensional molded panel for use in an electric fireplace and generally indicated at 334. Panel 334 is substantially identical to panel 234, having a top wall 360, bottom wall 362, side walls 364, 366 and a back wall 368. Panel 334 is manufactured in substantially the same manner as panel 234. In this second embodiment, however, back wall 368 does not incorporate a logset design and is generally planar in nature. Back wall 368 is molded to simulate other fireplace features such as the firebricks 378 and grout 380 shown in FIG. 16. It could, of course, be molded to represent stones or other similar features. Furthermore, bottom wall 360 is shown in FIG. 16 to be molded to include embers 376. Bottom wall 360 may, alternatively, be molded as a planar member and the embers may be painted onto the same. Alternatively, bottom wall 360 may simply be colored in a darker background color. When panel 334 is positioned within a fireplace frame in a like manner to the previous embodiment, a separate logset (not shown) with or without a grate and an ember bed may be positioned in front of the back wall 368. This separate logset may rest partially or entirely on bottom wall 362 and may be secured to one or both of bottom and back walls 362, 368 by a suitable means such as an adhesive or fasteners.

It will be understood that either embodiment of the three-dimensional panel may be used in conjunction with a diffuser screen (not shown) separating the panel from the light sources within the rotating cylinders, although the intent is that the panel act as the diffuser screen for the fireplace.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention are an example and the invention is not limited to the exact details shown or described.

1. An electric fireplace comprising:
a housing having a top, a bottom, opposing sides and a back;
a light source provided in at least one of the bottom and back of the housing;
a three-dimensional panel positionable in the housing in front of said light source; and
a pattern formed on the panel, said pattern being a representation of an interior of a firebox of a wood-burning fireplace.

2. The electric fireplace as defined in claim 1, wherein the panel includes:
a back wall;
a bottom wall extending outwardly and forwardly away from a bottom end of the back wall;
a first side wall extending outwardly and forwardly away from a first side of the back wall; and
a second side wall extending outwardly and forwardly away from a second side of the back wall.

3. The electric fireplace as defined in claim 2, wherein the panel further includes:
a top wall extending outwardly and forwardly away from a top end of the back wall.

4. The electric fireplace as defined in claim 3, wherein the top wall extends outwardly and upwardly away from the top end of the back wall and at a first angle thereto; and wherein the first angle is between 0 degrees and 90 degrees.

5. The electric fireplace as defined in claim 2, wherein the bottom wall extends outwardly and downwardly away from the bottom end of the back wall and at a second angle thereto; and the second angle is between 0 degrees and 90 degrees.

6. The electric fireplace as defined in claim 2, wherein each of the first and second side walls of the panel extends outwardly away from the first and second sides of the back wall and at a third angle thereto; and the third angle is between 0 degrees and 90 degrees.

7. The electric fireplace as defined in claim 1, wherein the panel is at least partially one of one of opaque, translucent and transparent.

8. The electric fireplace as defined in claim 1, wherein the panel is formed from one of a vacuum formable and a castable plastic.

9. The electric fireplace as defined in claim 8, wherein the panel has walls that are around 0.009″ to 0.125″ thick.

10. The electric fireplace as defined in claim 9, wherein at least a portion of the pattern is formed in the panel during molding and the pattern is a representation of one or more of bricks, stonework, a logset, embers and a grate.

11. The electric fireplace as defined in claim 10, wherein the pattern is further formed by the inclusion of one or more coloring agents.

12. The electric fireplace as defined in claim 11, wherein the coloring agents are included as one of an addition to a material that is molded to form the panel and a layer that is applied on one of an outer and inner surface of said panel.

13. A panel for use in an electric fireplace, said panel comprising a three dimensional molded member having a pattern formed thereon, said pattern being a representation of a firebox of a wood-burning fireplace; and wherein said panel is adapted to be positioned in front of a light source to aid in the creation of an illusion of a burning pile of wood within the fireplace.

14. The panel as defined in claim 13, wherein at least a portion of the pattern is molded into the panel and includes a representation of one or more of firebricks, stonework, a logset, embers and a grate.

15. The panel as defined in claim 13, wherein the panel includes:
a back wall;
a bottom wall extending outwardly and forwardly away from a bottom end of the back wall;
a first side wall extending outwardly and forwardly away from a first side of the back wall; and
a second side wall extending outwardly and forwardly away from a second side of the back wall.

16. The panel as defined in claim 15, wherein the panel further includes:
a top wall extending outwardly and forwardly away from a top end of the back wall.

17. The panel as defined in claim 16, wherein the top wall extends outwardly and upwardly away from the top end of the back wall and at a first angle thereto and the first angle is between 0 degrees and 90 degrees.

18. The panel as defined in claim 15, wherein the bottom wall extends outwardly and downwardly away from the bottom end of the back wall and at a second angle thereto; and the second angle is between 0 degrees and 90 degrees.

19. The panel as defined in claim 15, wherein each of the first and second side walls of the panel extends outwardly away from the first and second sides of the back wall and at a third angle thereto; and the third angle is between 0 degrees and 90 degrees.

20. The panel as defined in claim 13, where at least a portion of the pattern is formed using one or more coloring agents, said coloring agents being one of applied over and mixed into the molded panel.
